(19) United States
(12) Patent Application Publication
(10) Pub. No.: US 2002/0198892 A1
(43) Pub. Date: Dec. 26, 2002

(54) Method and system for point of purchase sign creation and delivery

(76) Inventors: William Rychel, Vernon Hills, IL (US); Richard Lytle, Vernon Hills, IL (US)

Correspondence Address: GARDNER, CARTON & DOUGLAS, PATENT DOCKET DEPT., 321 N. CLARK STREET - SUITE 3400, CHICAGO, IL, 60610, US

(21) Appl. No.: 10/101,993

(22) Filed: Mar. 20, 2002

Related U.S. Application Data
(60) Provisional application No. 60/277,442, filed on Mar. 21, 2001.

(51) Int. Cl. G06F 7/00

(52) U.S. Cl. 707/102

(57) ABSTRACT

A sign creation and delivery system for creating signs to be used at a point of purchase location. The system allows user access to five different modules: a sign creation interface module, a mass sign creation interface module, an order processing module, a client account management module, and a user account management module. The modules can be used together in various combinations to create the various advantages of the sign creation and delivery system. The sign creation and delivery system offers the ability for signs to be designed efficiently, with many levels of users involved with designing different signs, and with improved order processing speed through service site and remote site printing facilities. The invention also provides a method and system for collecting specific information about how the sign creation and delivery system is used by particular users, so that the system may be tailored to particular user needs.

### CROSS-REFERENCE TO RELATED APPLICATIONS

This application claims the benefit of U.S. Provisional Patent Application No. 60/277,442 filed on Mar. 21, 2001.

### FIELD OF THE INVENTION

This invention relates generally to a sign creation and delivery system. More specifically, the present invention relates to a novel, low-cost, efficient sign creation and delivery system that facilitates the advertising of products at their point of purchase; the method and system of the invention relies on a plurality of computers, computer networks, and printing devices, and on software implemented on them.

### BACKGROUND OF THE INVENTION

Advertisements for a product that are placed within or nearby the point at which the product is sold (i.e., the “point of purchase”) are more effective in convincing consumers to buy. This simple fact has created an important problem for businesses that operate nationally or internationally: how can up-to-date information about a product, which might be in the form of an advertisement, be distributed quickly to the hundreds or thousands of locations while delivering messages customized for each local market in which the product is sold?

Creating and delivering signs (also called “signage” by those in the field) has thus been a concern for businesses for as long as businesses have operated from more than one location. But in a conventional sign creation and delivery system, the time required for point of purchase sign creation and delivery is substantial, and the cost of delivering controlled, localized messaging for those signs is prohibitive. Sign creation for, and delivery to, the point at which a product is purchased is known to require several steps: first, a plan for how the signs are to be used is developed by a client, normally in cooperation with an advertising department, advertising agency, or graphics firm; second, a prototype of the sign, also called a concept proof, is created and delivered to the client for review; third, after approval has been received from the client, the sign is typeset and a plate, also called a proof, is created for printing the sign. Only at this point can printing and delivery of the sign begin.

Even if the signs are conceived, designed, and printed quickly, delivery to locations around the world (for a multi-national company) may take weeks, or even months. Delivery of a large number of signs to a variety of locations can be expedited, but at a high cost that cannot be recovered. The high cost might be minimized by a large company that relies on its internal distribution network to deliver the signs along with its product; but this method for delivery would not be desirable when only signs were to be delivered, as when the company seeks to liquidate its old inventory to make room for a new product. Furthermore, a small company may not have an internal distribution network available for delivery at all, forcing that company to rely on outside assistance for mass delivery of its signs, and a small company is even less likely to have the financial resources necessary for ordering expedited delivery. With conventional methods of sign creation and delivery, manufacturers do not have the resources to customize signs for each point of purchase at which a product may be offered; as a result, many signs that a manufacturer pays to print and deliver are never displayed.

For the foregoing reasons, conventional methods and systems for sign creation and delivery are slow and expensive. Such methods may require weeks or months to go from marketing ideas to real signs on location. Mass printing and delivery costs are very high, and do not allow for local customization or changes to be made quickly or at the last minute; the unfortunate consequence is that some signs are printed and delivered, but not displayed. Manufacturers may advertise a sale through newspapers, television, or radio, and yet be unable to create and deliver signs in time for the sale. As even the crudest signs may effectively communicate information to a customer (e.g., about a sale), it is common even today for a retailer to hand draw signs. Hand drawn signs may get the most important information across to a customer, but without company logos or control of brand identification images, these signs add little value to the product's brand image.

This is a serious disadvantage to the use of conventional techniques, since it is common today for manufacturers to conduct sales simply to increase brand equity, that is, to increase the added value a brand brings to the product it labels. The importance of brand equity has been proven in the business world through the successful marketing of brand name products over generics. Without a fast and accurate method for creating and delivering customized or localized signs to a point of purchase, manufacturers of brand name products are at the mercy of retailers to determine how and when their products will be presented. In many cases, the result is a loss in revenue and in brand equity—how glamorous is it to buy brand names advertised by a homemade sign?

Another disadvantage to more conventional sign creation and delivery results from a simple economic necessity: as production volume for a new product increases, companies will choose to conduct sales in an effort to liquidate the product inventory currently on store shelves. If signs cannot be created and delivered to the point of purchase quickly, businesses may end up with excess inventory, and be forced to delay the introduction of a newer product.

The foregoing discussion has been limited to the disadvantages in the use of conventional techniques of sign creation and delivery for a company that manufactures a product. There are also similar disadvantages for retail companies. A retail company may want to liquidate its old inventory by having a sale. In the past, such a retail company has few options. As a first alternative, it may create a hand written sign or use a generic sign that does not advertise the brand logo or named product; this alternative can result in consumer confusion, a less effective sale, or both. As a second alternative, the retail company may ask for a sign to be created for the point of purchase by the manufacturer or through an independent agency; but in this case, the retail company faces the same problems of time and money described above.

Retail companies do not always find it necessary to liquidate large inventories on short notice (as manufacturers often do); sign creation and delivery, therefore, is often left to the manufacturer. But manufacturers, unhappy about the high costs for creating and delivering signs to a point of purchase—and yet eager to protect their brand name—accept the burden, but in turn are unwilling to customize signs for a particular retail company unless that company provides many retail locations, so that the signs are widely distributed. Obviously, this is a serious problem for smaller retail companies, which are not considered for this bargain.

There are also negative side effects to the disadvantages of conventional techniques of sign creation and delivery: delay in creation and delivery of point of purchase signage results in fewer yearly promotions; there is less feedback or no feedback on the sales results of signs created for a particular point of purchase; retailers are reluctant to feature new brands without timely promotional point of purchase advertising. With a dramatic increase in the number of new products offered, and the corresponding decrease in available shelf-space, retail markets are more competitive than ever. The need, therefore, exists to provide manufacturers, distributors, and retailers with a method and system of sign creation and delivery that offers a faster, higher quality, and cost efficient method of producing customizable signs for a point of purchase.

### SUMMARY OF THE INVENTION

The foregoing limitations and disadvantages of the conventional techniques of sign creation and delivery are overcome by the present invention, which provides a customizable, faster, higher quality, and less expensive sign creation and delivery system. According to one embodiment of the present invention, the sign creation and delivery system allows users, including retailers and regional retail managers, to access information databases, which may comprise a content database, to create signs customized for placement at a particular point of purchase.

From the content database, users may select sign templates with variable fields for text and various graphic images. After selecting a particular template, the user inputs the appropriate data into the variable fields. The content of the variable fields might be, for example, numerical prices or percentages. When the sign's content has been decided, the user may further select from a set of options for how the sign is to be printed, e.g., the material used, the thickness of that material, or its size. The user's order may then be submitted for processing.

The use of a content database of sign templates creates new advertising possibilities for users of the sign creation and delivery system. Users of the system can, for example, keep different sets of templates with the same graphical content, but with the writing in different languages. Retailers that access the sign creation and delivery system can then choose signs that their customers will be able to read. In the past, signs were often printed only in one language because the cost of designing and printing signs for a minority of customers was prohibitive. The efficiency created by the present invention allows for larger numbers of customers to be reached. The sign creation and delivery system of the present invention thus creates unprecedented opportunities for marketing to smaller demographic groups within a larger market.

Order processing includes printing and delivery of the order. The time needed for order processing varies with the embodiments of the present invention; in some embodiments of the invention, order processing may be nearly instantaneous. According to one embodiment of the present invention, signs may be printed by a printing facility service, and delivered by a shipping service to a point of purchase. In another embodiment, however, signs might be available almost instantaneously if they are produced by a printing facility remote to the sign creation and delivery system. In another embodiment of the present invention, wherein the point of purchase is owned by a large retail company, that company might choose to maintain a high quality sign printing service at a regional facility, for faster delivery to the points of purchase local to that facility. In every embodiment, the user has direct control over the design and production of the signs; the present invention, therefore, presents a faster embodiment than any conventional method of sign creation.

A further advantage of the present invention is its ability to mass produce custom signs for use at points of purchase that may exist in many different locations throughout the country. The ability to mass produce and deliver signs on the fly provides large volume manufacturers an unprecedented opportunity to move large inventories of their products. Allowing a manufacturer to customize the information displayed about their product at the point of purchase will speed-up the introduction of new products.

Another important aspect of the present invention is its facility for gathering and distributing information about how and when signs are being used by different points of purchase. The system allows for information to be captured regarding what users are ordering what point of purchase signage and what messages and prices are being advertised. This is a valuable aspect of the present invention: if the data about advertising can be combined with data about actual sales, marketing can be done far more efficiently than ever before. For example, the combination of this data, and its analysis gives manufacturers and retailers information on the effectiveness of particular promotional campaigns, and the sales that resulted therefrom. The present invention's capacity for gathering, storing and analyzing information about how signs are ordered and placed is therefore useful to manufacturers in determining trends, in managing inventory and production, and in tracking the preferences and sales performance of particular points of purchase.

Since its electronic implementation may require user identification, the present invention presents an additional advantage in that it can be configured to run differently in different geographical regions. This advantage may be more than a mere convenience in the case where signs for the points of purchase within a particular geographical region must comply with specific legal requirements not made by other regions. Within the system of the invention, signs created may be checked before order confirmation, printing, and delivery; checking ensures compliance with advertising laws and ordinances that may apply to a specific geographical region.

In an embodiment, the sign creation and delivery system and method of the present invention is accomplished with five different modules: a sign creation interface module, a mass sign creation interface module, an order processing module, a client account management module, and a user account management module.

The sign creation interface and mass sign creation interface modules are the primary interface between a user of the sign creation and delivery system in the design phase. These modules allow for a plurality of different users to contribute to signage design in a variety of roles. The improved efficiency in design and design approval with these aspects of the present invention are substantial, and are unprecedented. Users of sign creation interface modules can work with sign templates that have content meant to be shared throughout all of the points of purchase within a certain group of points of purchase. Such a group might be organized (using the client account management module described below) by the retail company that owns the point of purchase locations, by the geographical location of points of purchase, or by some other suitable organization criterion. With the sign templates available to a particular user, that user can make adjustments to variable fields within the sign templates to include up-to-date price information, sale percentages, or logos and trademarks associated only with a particular group of point of purchase locations. There is no need to hand draw this information, as has been necessary in the past.

The order processing module is a method and system within the sign creation and delivery system for processing sign creation and mass sign creation orders more quickly and efficiently than has been possible in the past. In an embodiment, the order processing module is automated, and the result is a quicker turnaround on orders submitted through the sign creation interface modules, so that even when orders are submitted for printing through a printing service, the signs are distributed to points of purchase more quickly than has been possible in past.

In addition to providing a method and system for configuring the content available to users, the client account management module provides a method and system for collecting and using information about each user of the sign creation and delivery system, so that the system's interface may be tailored to the individual needs of that particular user. The sign creation and mass sign creation interface may look different and have different content accessible for each user of the sign creation and delivery system; the flexibility of the present invention allows for a variety of different companies in a variety of different industries to make use of the system in meeting their point of purchase signage needs.

The user account management module, in an embodiment of the present invention, provides a way for users of the sign creation and delivery system to update their own account information kept within the system. This allows for users to specify preferences for the content and appearance of the interfaces within the system, and to update information such as addresses, phone numbers, and billing information kept within the system.

### BRIEF DESCRIPTION OF THE DRAWINGS

The foregoing and other objects, advantages, and features of the present invention will be apparent from the following detailed description and the accompanying drawings, in which:

FIG. 1 is a block diagram showing the sign creation and delivery system in accordance with an embodiment of the present invention;

FIG. 2 is a flow diagram showing the function of the sign creation interface in accordance with an embodiment of the present invention;

FIG. 3 is a flow diagram showing the function of the mass sign creation interface in accordance with an embodiment of the present invention;

FIG. 4 is a first part of a flow diagram showing a method of processing order information for signs to be placed at points of purchase in accordance with an embodiment of the present invention;

FIG. 5 is a second part of a flow diagram showing a method of processing order information for signs to be placed at points of purchase in accordance with an embodiment of the present invention;

FIG. 6 is a flow diagram showing a method of client account management in accordance with an embodiment of the present invention; and

FIG. 7 is a flow diagram showing a method of user account management in accordance with an embodiment of the present invention.

### DETAILED DESCRIPTION OF THE INVENTION

While the present invention is susceptible to various modifications and alternative forms, certain preferred embodiments are shown by way of example in the drawings and will be described in detail herein. It should be understood, however, that it is not intended to limit the invention to the particular forms described; on the contrary, the invention is intended to cover all modifications, alternatives, and equivalents falling within the spirit and scope of the invention defined by the appended claims.

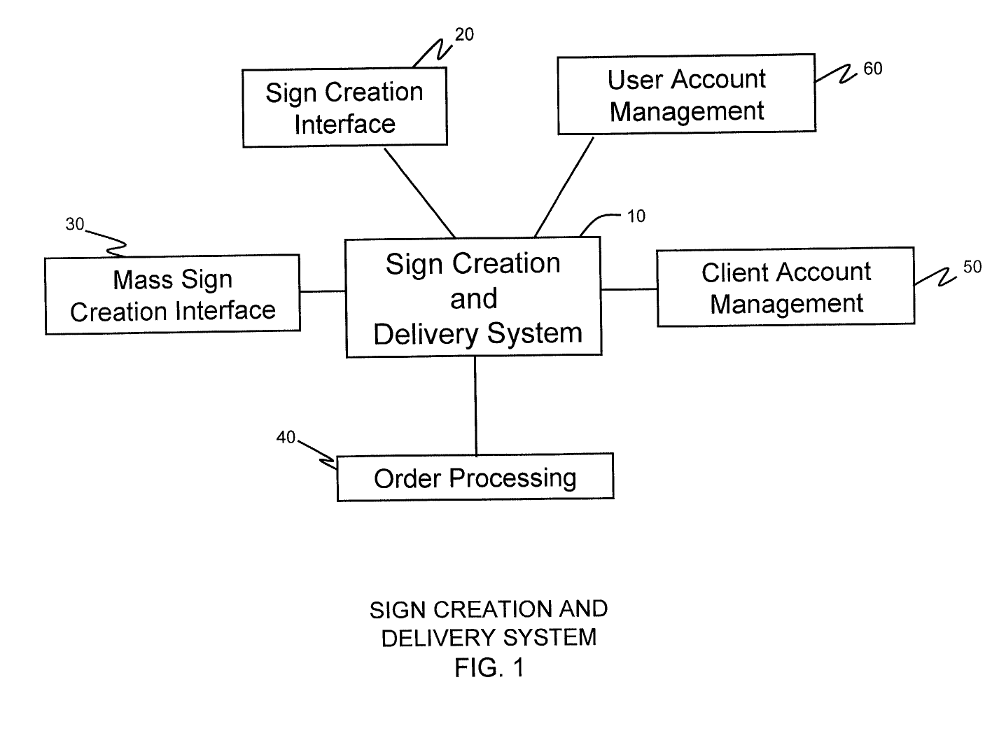

FIG. 1 is a block diagram of the logical structure of a sign creation and delivery system, according to an embodiment of the present invention. As shown in FIG. 1, there are five modules that comprise the sign creation and delivery system 10. The five modules include a sign creation interface module 20, mass sign creation interface module 30, order processing module 40, client account management module 50, and user account management module 60. These modules work together to perform the functions of a sign creation and delivery system, although the modules may or may not appear in some embodiments of the present invention, as they are deemed necessary or not necessary by one of ordinary skill in the art in practicing the present invention of sign creation and delivery. For example, the sign creation interface might be left out in an embodiment of the invention in which only mass sign creation is deemed necessary.

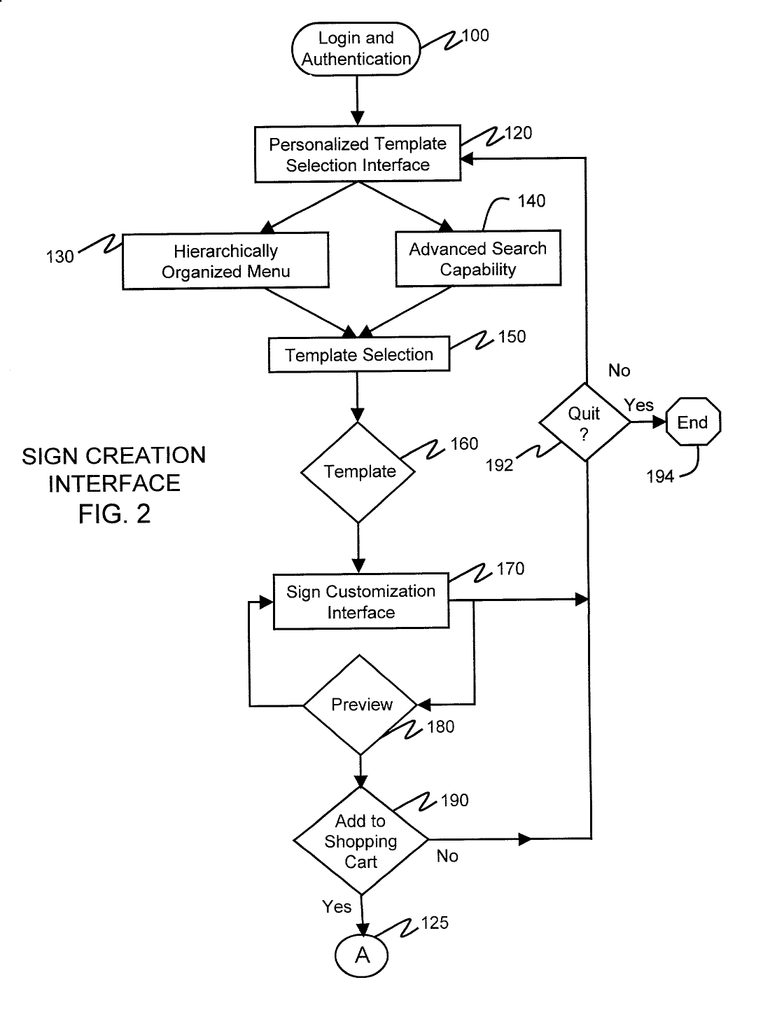

In FIG. 2 is shown a flow diagram of the function of the sign creation interface in accordance with an embodiment of the present invention. Users may access the sign creation and delivery system by login and authentication 100 from a computer or wireless communications network connected to the Internet or other suitable wide area network arrangement. For example, a user may use a computer or wireless device to initially establish a connection to the Internet and then utilize a browser on the World Wide Web to access a particular URL associated with a web site associated with the sign creation and delivery system.

Because of the widespread use of the Internet, the interfaces for the sign creation and delivery system 10 might be implemented using software that is compatible with the Internet, and especially with the World Wide Web. Currently, HTML is a standard format for the presentation of a web based software interface, but it should be understood that in the future the present invention might be implemented with a newer standard, such as XML, VRML, or Voice XML, as such standards become available. The interface for the sign creation and delivery system 10 need not be limited, therefore, to the typical personal computer or laptop interface used for connection to the World Wide Web. The present invention might be used through a cell phone, personal digital assistant, or other such device; it might even be implemented through an audio system, such as a voice activated speech recognition system, when sign templates have been previewed through an attached visual display.

After authenticated login 100, the personalized template selection interface 120 is displayed. The personalized template selection interface 120 may be defined, in an embodiment of the present invention, by one or more managers of the sign creation and delivery system through control of the content database 570 to which the personalized sign template selection interface 120 is connected. This aspect of the invention will be further discussed with the client account management module 50, below. The personalized template selection interface 120 might have a “NEW PRODUCTS” or “FEATURED PRODUCTS” section, which includes sign templates or other products that have been matched to a particular user through client account management module 50, whereby the personalized template selection interface 120 may be customized in details of stylistic appearance and function for particular users or groups of users. For example, in an embodiment the writing shown in the interface might be in any one of a plurality of different languages designated as the language of a user with the client account management module 50. In another embodiment, a “FINISHED GOODS” section might be included in the personalized template selection interface showing a list of the sign templates that a particular user may have created in a past use of the system; the FINISHED GOODS section allows frequent users of the sign creation and delivery system 10 to save time that they may otherwise have spent customizing sign templates for repeated orders. From the personalized template selection interface 120, users may be prompted to search 140 or select from a predetermined set of sign templates 130 based upon information stored within the sign creation and delivery system 10 content database 570.

In an embodiment, a user might select a template for use within the system by navigating a hierarchically organized menu structure 130. The top menu might be a menu of different brands that have been associated with that particular user. After the user selects one of the brands (e.g., “ACME”), another menu, which has a selection of products associated with that brand might appear. The user might then select a product, e.g., “CORDLESS DRILL”, whereupon another menu of signage types (e.g., “BANNER”) might be displayed. Other menus might be displayed upon selection of signage type, including menus for sign category (e.g., “CHRISTMAS”). In the end, after “drilling down” through this hierarchy of menus, the user selects from a set of sign templates, which might be labeled with any combination of letters and numbers, e.g., “29548a”; this step is labeled 150 in FIG. 2. The templates might further be shown in the menu by a thumbnail picture, a short description, and a name 160.

Using the client account management module 50 of the sign creation and delivery system, the hierarchically organized menus may be organized according to a user's geographic location. Certain users may associate themselves, through the user account management module 60, with certain geographic areas. Using this association, the client account management module 50, can make certain sign templates unavailable for certain users. By allowing only certain templates to be selected for certain users, sign template use may be restricted to certain geographic regions. This is an important feature of an embodiment of the sign creation and delivery system 10; it ensures that the signage created is in compliance with local rules and regulations or other advertising ordinances, which may vary depending on the users geographic location. As local rules and regulations change, the client accounts management module 50 can be used to update and revise sign templates to comply with new laws. Thus, the present invention allows all users of the sign creation and delivery system 10 to be in compliance with local laws.

As is readily apparent from FIG. 2, a user may also avoid the navigation of menus by doing a search of the sign templates 140 available to that particular user. Such a search might be performed, for example, by querying a database for a keyword in a sign template description field, name field, or number field.

After using either the hierarchically organized menu 130 or the advanced search capability 140, a user makes a sign template selection 150, and is presented with a large image of the sign template 160, with entry fields for variables. The entry fields for variables may include, for example, product price, sale period, retailer identification information or other information useful in making the signage more meaningful for consumers or retailer such as a logo or trademark. The user inputs data into the appropriate fields using the sign customization interface 170. In an embodiment, the sign creation interface module 20 might also allow users to exit the sign customization interface 170 and return to the personalized template selection interface 120 to select a new sign template (after deciding first whether or not to quit 192 and end 194 the sign creation interface module 20 session entirely).

The sign customization interface 170 includes, in an embodiment of the present invention, a logo storage and retrieval facility. The logo storage facility allows users to upload a logo image, in the form of a graphics file that they may have created or scanned into a local computer; it allows for users to make image files available to other users of the sign creation and delivery system 10, although there may be constraints on image sharing among users determined by the client account management module 50. Users that are not associated with a particular client would not be allowed access to the image files kept in the logo storage facility by that user. Using the logo storage facility of the sign customization interface 170, users might be able to add images to a sign template, and scale those images to fit variable fields within the sign template that they have selected. In another embodiment of the present invention, the scaling of a graphic image to be included in a template might be done automatically by the system, with the sizing of the graphic image determined by the variable space available on the template.

According to an embodiment of the present invention, users of the sign creation interface module 20 and mass sign creation interface module 30 would not have to work with full, high resolution images of the sign templates to be used; “thumbnail” images of the sign templates might be used instead. A thumbnail image of a sign template might simply be a reduced or compressed image file associated with the larger, full-scale, high resolution image of a sign template that will be used in printing. By working with these thumbnails, the computers that comprise the sign creation and delivery system 10 can operate more efficiently. According to an embodiment of the present invention, the thumbnail image might be a scaled down JPEG format image that represents the high resolution PDF file that will actually be sent to a printer. Bandwidth and processing power are limited, and in some cases the savings of time created by the use of such thumbnail images of the sign templates may be substantial, and their similar use in order processing is discussed further below.

A primary advantage of the present invention is the ability for users to make instantaneous changes online to point of purchase sign templates. This allows for signs to be updated quickly and easily to accommodate new sign needs that arise for a variety of reasons such as a need for shelf space, a product change, promotional sales.

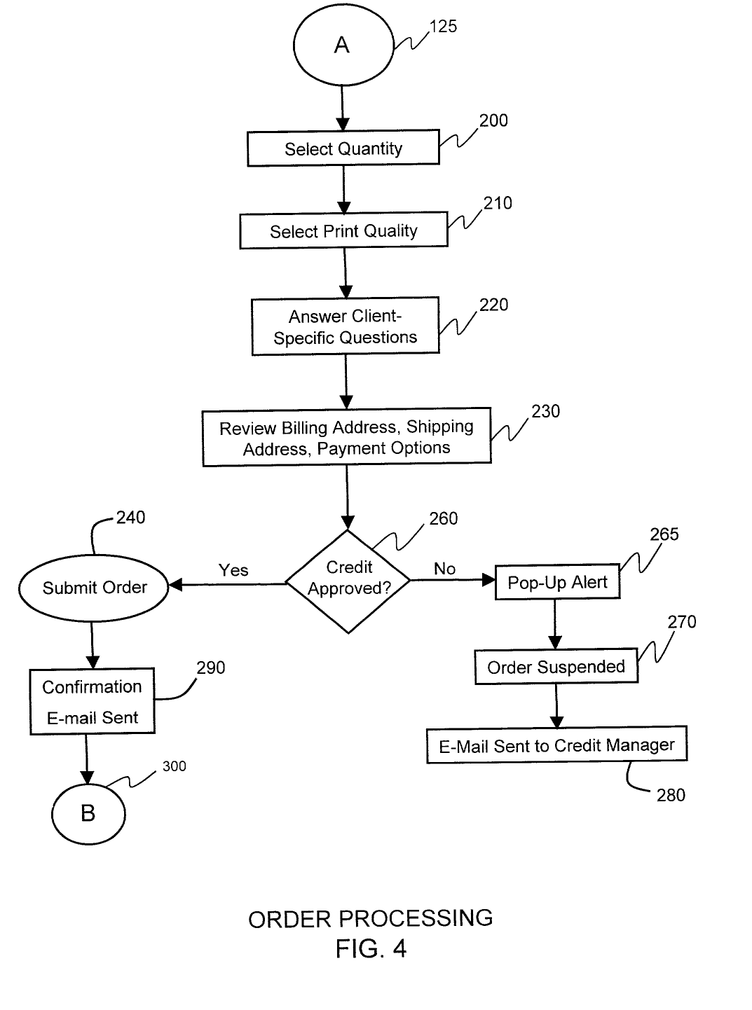

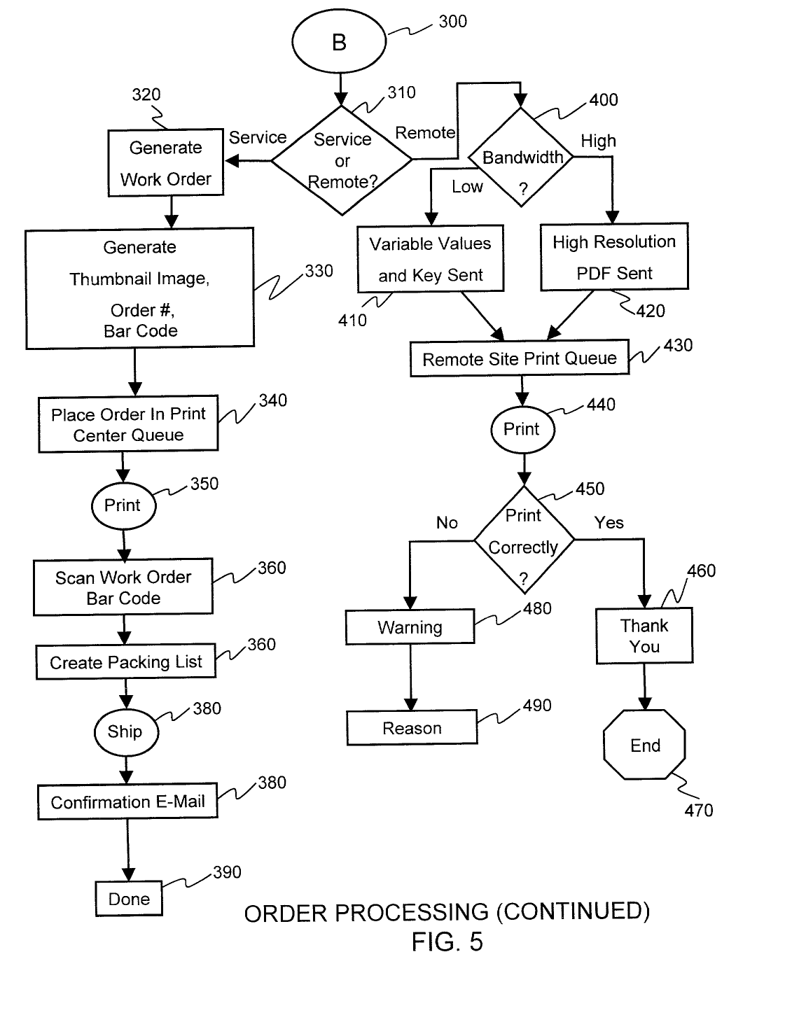

The sign creation interface module 20 also allows for sign templates to be previewed 180 after they have been customized with the sign customization interface 170. The preview shows the sign template, with its variable fields filled out including any writing or pictures that they may have added to the sign template. Logos or trademarks included in the template are assigned coordinates within the template for them to be centered on, and are scaled proportionally to fit within an area defined around the central coordinates. If a user accepts the previewed sign, then he or she is asked if the sign should be added to a shopping cart 190; if yes, then the order in the shopping cart is submitted for order processing (the circle labeled “A” is connected to the order processing flow diagram shown in FIGS. 4 and 5); if not, then the user is asked to decide whether he or she wants to quit 192 and end 194 the sign creation interface module, or to be returned to the personalized template selection interface 120 to find a new sign template. In an embodiment of the present invention, when a new sign is accepted for printing, it might also be stored in a content database 570, so that it can be searched for or found through the personalized template selection interface 120 in the future.

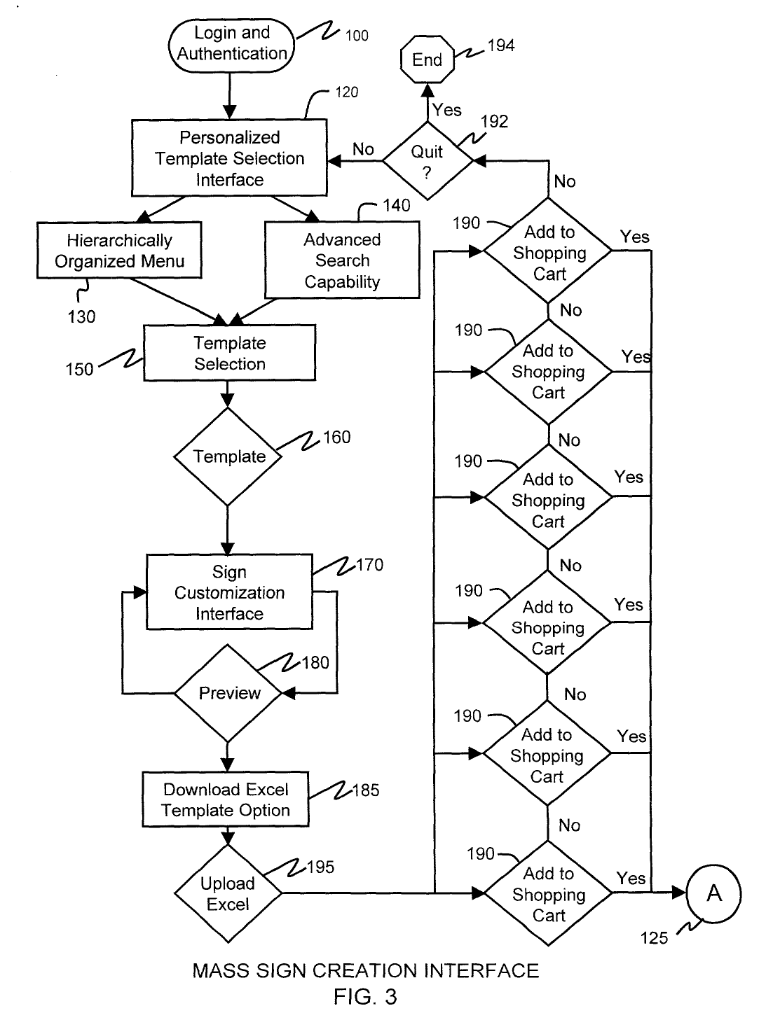

The sign creation and delivery system 10 may also provide, in another embodiment, a mass sign creation interface module 30. As is apparent from FIG. 3, the mass sign creation interface module 30 is similar to the sign creation interface module 20; the login and authentication 100, the personalized template selection interface 120, hierarchically organized menu 130, advanced search capability 140, template selection 150, template display 160, sign customization interface 170, and preview 180 of customized sign templates are all similar to the sign creation interface module 20; the differences are determined by additional options that may appear in the interface that are useful in high volume sign creation only. In the mass sign creation interface 30, there is an option for download 185 and upload 195 of a spreadsheet file, such as, for example, a common format spreadsheet file, to and from the mass sign creation interface 30 module. Using these spreadsheets, users may specify the following for a plurality of signs to be produced using a sign template: names of distributors or retailers, names of products, prices of products, and other information that may vary from sign to sign for a high volume production of signs. Another advantage of the present invention is that a user of the sign creation and delivery system 10, for example, a person working for the marketing department of a company that wants to produce a large number of signs for delivery to a plurality of retailers or distributors, has direct access to sign creation facilities through the mass sign creation interface module 30. This direct access, which allows for a much faster design phase of sign creation, is a significant improvement over prior systems for sign creation and distribution.

According to an embodiment of the present invention, after a template has been created and previewed 180, the mass sign creation interface module 30 of the sign creation and delivery system 10 creates a spreadsheet file containing all the necessary columns for mass production of a particular sign template. The columns are based on the names of the variable fields that appear in the sign template. This spreadsheet file may be sent as an email attachment to a user, and downloaded 185 by that user. Using the spreadsheet file, the user can enter field and sign specific information into each column and row. The user then has the ability to upload the completed spreadsheet file directly to the mass sign creation interface module 30, and to preview and add each sign 190 to the shopping cart using a leaf through interface. In another embodiment, users might also have the option to accept new signs for printing without previewing them. Sign that have been added to the shopping cart 190 through the mass sign creation interface module 30 are then sent to the order processing module 40 (the circle labeled “A” connects to the order processing module; see FIG. 4). After all of the signs have been previewed, if none of them have been added to the shopping cart 190, the user has the option of quitting 192 (ending 194 the mass sign creation interface module 30 session) or returning to the personalized template selection interface 120.

FIG. 4 is a first part of a flow diagram showing a method of processing order information for signs to be placed at points of purchase in accordance with an embodiment of the present invention. The first step of order processing, selecting the quantity of signs 200, follows the circle labeled “A” 125, which is also shown in both FIG. 2 and FIG. 3 because order processing follows sign creation or mass sign creation in an embodiment of the present invention (in other embodiments, order processing might be initiated more directly). In this way, FIGS. 4 and 5 are continuations of a larger control flow process that begins with either FIG. 2 or FIG. 3.

The selection of sign quantity 200 might be limited, in an embodiment of the present invention to less than a certain quantity through the client account management module 50 in order to prevent accidental or abusive use of the sign creation and delivery system. After selecting sign quantity 200, the user might then be prompted to select the print quality of the signs 210 from a several different print quality options, which might be given, for example, in terms of dots per inch (DPI). The user might then select one of those options from a drop-down menu, or from some other audio or visual listing of these options.

In addition to selecting sign quantity 200 and print quality 210, certain users of the sign creation and delivery system 10 may be asked client-specific questions about the order 220. Such questions may be tailored, through the client account management module 50 to provide information to the manager or managers of the sign creation and delivery system 10 that will aid them in tailoring the sign creation interface module 20 and mass sign creation interface module 30 to the specific needs of a client user. These client-specific questions 220 might be skipped or postponed in an embodiment of the invention if the answers are not available for the user.

The order processing module 40 allows for information that is necessary for final printing or delivery of the signs produced to be reviewed before submission of a sign or signs in step 230. As shown in FIG. 4, a user of the order processing module 40 may review information such as billing address, shipping address, and payment options before submitting his or her order. In an embodiment of the present invention, the billing address, shipping address, payment options, or other information that is reviewed might be defined using the client account management module 50, the user account management module 60, or both. For example, using the client account management module 50, a manager or managers of the sign creation and delivery system 10 might limit credit available to a particular user or users of the system. In this way, users are not able to accidentally submit orders that are far larger or more expensive than the credit line they have available to them. False orders might be prevented with this method of managing the sign creation and delivery system 10 through the client account management module 50. The review of information in this step 230 might also be linked with the user account management module 60, so that users can modify the information kept through the user account management module 60 (such as billing or shipping addresses) in this step rather than having to exit order processing in order to modify this information.

After the information, such as billing address, shipping address, and payment options has been reviewed 230, the sign creation or mass sign creation order in the shopping cart may be submitted for a credit check 260. Credit checks are initiated to determine whether a particular user has credit available to finance the submitted order.

In the event that the credit approval is denied, a sequence is initiated in which notification, such as a pop-up alert 265 or chime alert, is provided to a user of the system that credit available is insufficient for the order to be processed immediately. The submitted order might then be suspended 270 by storing the order in a database where it may be resubmitted after credit has been secured. Finally, in an embodiment of the present invention, an email might be sent to a credit manager 280 for the sign creation and delivery system 10, notifying him or her of the suspension of a submitted order, the nature of the order, and the identity of the user who submitted the order. The credit manager might then take action as he or she sees fit in order to see the order processed.

If credit is approved, then the order is submitted 240, and an email confirmation of the submitted order is sent to the user 290, providing details about the nature of the submitted order. The second part of the order processing sequence is shown in FIG. 5, which is connected to the order processing sequence of FIG. 4 through the circle labeled “B” 300 in FIG. 4 and FIG. 5.

Referring to FIG. 5, there is shown a second part of a flow diagram showing a method of processing order information for signs to be placed at points of purchase in accordance with an embodiment of the present invention. The second part of the order processing sequence begins, after the circle labeled “B” 300, with the determination of whether a submitted order is for SERVICE or for REMOTE printing 310.

If the order is for SERVICE printing, then a work order is immediately generated 320 at a printing service site, which might be in house for the company that owns the sign creation and delivery system 10, or might be at another site owned or hired by a corporate client of the company that owns the sign creation and delivery system 10. The work order might comprise, for example, specific order information, a product thumbnail image, a unique order number, and a bar code. The bar code might be used to track the order during the remainder of order processing, and might be used to collect statistics through the client account management module 50 on how long a particular user's order takes to process. After the work order has been generated 320, all of the information about the order might also be stored in a database, and associated with a particular thumbnail image, for access by the user with the personalized template selection interface 120 in the future. In this way, a user might avoid having to go through the same sign creation or mass sign creation steps in order to produce an order they had already submitted if later that user decides to make small changes to the order and resubmit it.

The order might be placed in a printer queue 340 after a work order has been generated 320, and the order has been stored for future use in a database 330. Depending on the number of orders in the queue, the order may then be printed 350 within seconds or within minutes of the order submission 240.

When printing 350 is complete, the work order bar code might be scanned 360, triggering the creation of a packing list 370. With the packing list, the order is packaged either by a human or by a computer controlled packaging system, which might rely on robotics, sorters, feeders, or other automated devices, as might be known to one of ordinary skill in the art. In an embodiment, the final steps in the method of SERVICE order processing are shipment to the user 380 through a shipping service, and the sending of email confirmation that the order has been shipped 380. Tracking numbers, which might be provided by a commercial shipping service are automatically entered into a database within the sign creation and delivery system 10, and the confirmation email 380 might have these numbers.

The method of REMOTE order processing begins, according to an embodiment of the present invention, with a choice by the user of whether a remote printer has a high bandwidth or a low bandwidth connection 400 to the sign creation and delivery system 10. This choice might not be made with the submission of each order; rather, it might be configured for specific users of the sign creation and delivery system 10 through the client account management module 50. If a remote printing facility is connected to the sign creation and delivery system 10 through a low bandwidth connection, then only variable fields values and an encryption key might be sent to the remote printing facility 410. The encryption key might be used to decrypt image files kept at the remote printing facility, but inaccessible to the client without the encryption key. The encryption key might be set up to expire after a single use. Other methods might also be used to ensure that image files kept at a remote printing facility are not accessible, accept after proper order processing. With the encryption key and the content of the variable fields, printers at a remote printing facility might then accept an order into a printing queue 430. Suitable encryption schemes, such as ECC, RSA, DES, or DESX are known to those of skill in the art. If the connection established between a remote printing facility and the sign creation and delivery system 10 is a high bandwidth connection, then high resolution image files, such as PDF or TIFF files might be sent to the remote printing facility 420 instead. Appropriate security techniques are used for high bandwidth transfers; for example, transfer through the Secure Sockets Layer (SSL) may be necessary if the connection between the remote printing facility and the sign creation and delivery system 10 is through a network. Other security techniques, such as signal encryption or timeouts might be used if the connection is maintained through a wireless network. After high resolution images have been sent 420, the order is sent to the printer queue at the remote printing facility 430.

Orders are processed through the printer queue 430 on a first in, first out (FIFO) basis. According to an embodiment of the present invention, once an order has printed 440, a prompt in the form of a pop-up display or audio recording may ask a user of the order processing module's 40 REMOTE processing option whether or not the order submitted has been printed correctly 450. If yes, then a thank you message in the form of a pop-up display or audio recording might be sent to the user 460, and the order processing is finished 470. If no, then another sequence is initiated with, in an embodiment of the present invention, a warning message 480, with information on proper usage of the reprint function and a selection for each version of a sign or signs submitted with the order. Upon selecting a sign or signs for reprinting, the user is presented with a form 490 with two required fields: “reason code” field, which might be selected from a drop down menu or a recorded list of reason codes, and an “explanation” field, which might be simply an open field for text entry to be transferred and stored in a database within the sign creation and delivery system 10 for review by a manager or managers of the system. In an embodiment, the user that opts to reprint must complete the reason code and explanation fields within a certain time limit, e.g., 15 minutes, for the order to be put back in the print queue 430 and reprinted 440. The reprint option may not be available after a second printing.

In addition to the foregoing sign creation interface 20, mass sign creation interface 30, and order processing 40 modules, the sign creation and delivery system 10 also offers, in an embodiment, a client account management module that allows for access to the sign creation and delivery system 10 to be organized, sign templates and other content (such as logo images) for particular users to be managed, and for information about user activity to be collected and used to customize and improve the modules of the sign creation and delivery system 10 for particular users of the system.

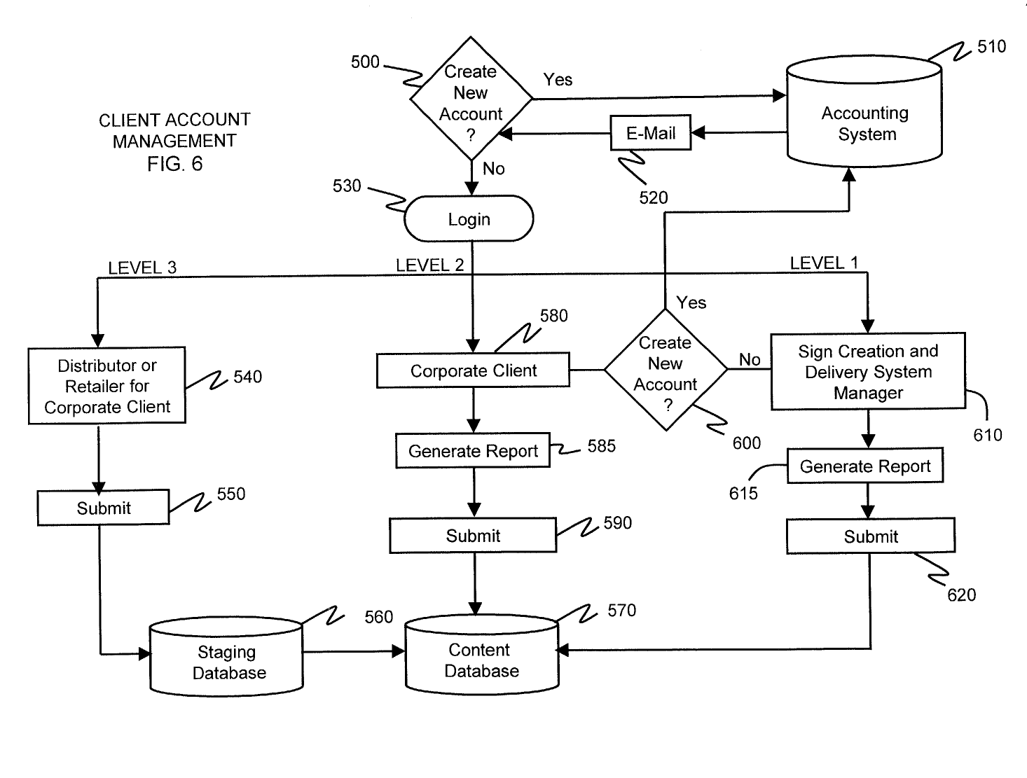

In FIG. 6 is shown a flow diagram of a method of client account management in accordance with an embodiment of the present invention. All users of the sign creation and delivery system 10 must create an account with the system before using it; accordingly, before login, a potential user may choose to create a new account 500 or to instead to progress to login 530. If the user chooses to create a new account, then he or she is directed to the accounting system 510, which might be linked to a commercial credit check service, or might provide a simple database for new client information to be entered, sorted, or approved by a manager of the client account management module 50. The process of new account creation might be automated for certain users; for example, a large corporate client that might have many users accessing the sign creation and delivery system 10 might be designated, through the accounting system, to have accounts setup automatically when they are requested from secure IP addresses that are associated with that company.

According to an embodiment of the present invention, when a new account is requested from the accounting system 510, a credit check is performed; if approved, the new account is created with a first time only user identification information, for example, a user identification phrase and password that expire after one use. The user of the newly created account is sent an email 520 with first time only user identification information. The user is required to change his or her user identification phrase and password after first accessing the system. First time only user identification information might expire after a certain time period to help prevent unauthorized users from accessing the system.

According to another embodiment of the present invention, there are three different levels of user access, shown in Table 1 below; users are given LEVEL 1, LEVEL 2, or LEVEL 3 access after login. One important feature of the client account management module 50, is that the accounting system 510 can be used, when accounts are created, to decide whether a new user has LEVEL 1, LEVEL 2, or LEVEL 3 access to the sign creation and delivery system 10. This feature allows for users to interact with the system in a variety of ways, and to cooperate more effectively in designing new signs for production. The efficiency created by allowing all levels within a company to cooperate—from a commercial artist, to an artistic director, to a marketing department executive, to a CEO—is unprecedented. Never before have companies had such complete information and flexible control over their sign creation.

The capabilities prescribed for the different user access levels are shown in Table 1, and are further discussed in the description of client and user account management herein. In an embodiment of the present invention, LEVEL 1 users might be only the manager or managers of the sign creation and delivery system 10. The LEVEL 1 user has full administrative access to the system, and can add, edit, delete, inactivate, or reactivate any of the content kept anywhere in the system. LEVEL 1 users might also be able to add, edit, delete, inactivate, or reactivate any user accounts within the system, or may add, edit, or delete user profiles for these accounts. LEVEL 2 users might be employees of a corporate client that has purchased access to the sign creation and delivery system 10. LEVEL 2 users have authority to add, edit, delete, inactivate, reactivate, or view any templates and options that have been associated with the user accounts for that corporate client. LEVEL 2 users also have the ability to grant or deny LEVEL 3 user access to the content associated with them. In another embodiment of the present invention, there may be a subset of LEVEL 2 user access in which employees of corporate clients who provide graphic art for signage are allowed also to contribute image files to the content database 570 that may be used as sign templates. Such a user might have the same abilities as another LEVEL 2 users, except for the ability to grant or deny LEVEL 3 user access. LEVEL 3 users might be distributors or retailers for the corporate client with LEVEL 2 access. Such users would still have access to the sign creation interface module 20, mass sign creation interface module 30, and order processing module 40, but they would have no ability to control the presentation of content within these modules or to control user access to the sign creation and delivery system 10.

TABLE 1
An Embodiment of Access Levels
in the Sign Creation and Delivery System

| | |
|---|---|
| LEVEL 1 | Allows: upload of graphics files, creating and editing of file |
| | attributes for variable fields of sign templates, |
| | setting of active dates, assignment of final |
| | template to a catalog category, viewing and editing of field |
| | attribute variables of sign templates, |
| | and deletion of sign templates. |
| LEVEL 2 | Allows: creation and deletion of sign templates, conversion |
| | of graphics files to templates, and sorting of |
| | templates by category, and promotion of approved |
| | templates to the live catalog. |
| LEVEL 3 | Allows: editing and deletion of template-client associations. |

An important advantage of the present invention is that it allows LEVEL 1 and LEVEL 2 users to gather information about users with access levels below them, by compiling statistics on who makes changes, what changes are made, and when those changes are made to the content database 570. The statistics compiled might then be used to generate reports on the use of the sign creation and delivery system 10 by lower level users. This information is useful, for example, to a manufacturer, who can then analyze the ordered products to determine the types of ordered products that are most effective and beneficial to other users, such as retailers. The manufacturer can review ordering trends by geographic region, thus enabling the manufacturer to create additional point of purchase signage in relation to those trends, or to better manage inventory and production in a manner that corresponds to those trends. By tracking retailer performance and preferences, the manufacturer can better target specific products to specific markets and thus increase overall sales. Similarly, a manager (LEVEL 1 user) of the sign creation and delivery system 10 has the ability to tailor the modules of the system for the needs of particular LEVEL 2 and LEVEL 3 users. Examples of reports that might be generated on the use of the system include reports on what content is accessed, when it is accessed, and by what users it is accessed. Using this information, manufacturers could also more effectively manage inventory. By using the signage creation information at the retail level as an indication for demand of a product, a manufacturer can supply additional inventory or move more inventory to locations where certain products appear to be in greater demand. These advantages are unprecedented, and create a great opportunity for improved efficiency and quality in sign creation and delivery for points of purchase.

In FIG. 6, after login 530, a user of the client account management module will have different options available to them depending on what user access level he or she has been assigned to, as shown in the table, and described above. LEVEL 1 and LEVEL 2 users have the ability to create new accounts 600 and delete old accounts from the accounting system 510. All levels of users have the ability to submit changes to the content database 570, although, in an embodiment of the present invention, the changes submitted by LEVEL 3 users may be kept in a staging database 560 before being approved by LEVEL 1 or LEVEL 2 users for the content database 570. A similar staging database or other system might be implemented for the creation of accounts through the accounting system 510. The content database 570 is a centralized repository of all the information kept within the sign creation and delivery system 10; it may, as in the embodiment shown, be accessible to users through a network such as the Internet. Suitable security measures for protecting the content database 570 from unauthorized access have been discussed above. As discussed above, LEVEL 2 and LEVEL 3 users also have the ability to generate reports 585 and 615 about users of the system at or below their access level, too.

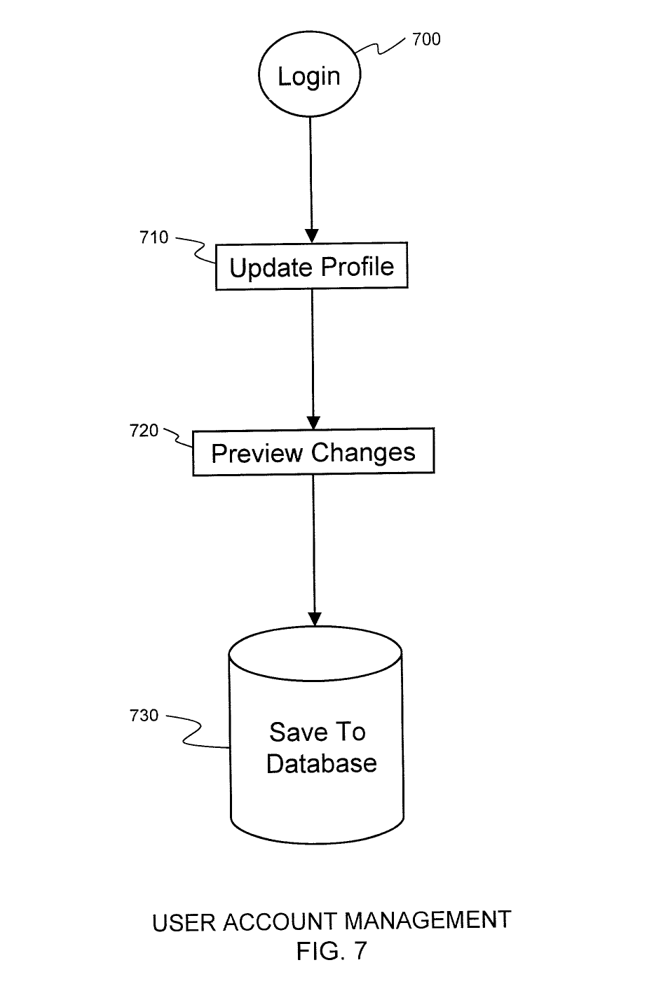

FIG. 7 shows a flow diagram of a user account management module 60 in accordance with an embodiment of the present invention. The user account management module 60 is available to users of the sign creation and delivery system 10 primarily as a means for updating information about names, addresses, phone numbers, fax numbers, billing, and other related information. As shown in FIG. 7, after login 700, the user might be presented with an option to initiate the user account management module 60. Upon selecting this option, the user may be presented with an HTML form or a recorded prompt to enter or record user information (this step is labeled “UPDATE PROFILE” 710 in FIG. 7). The updated profile created in this step may then be previewed 720, and either the information is accepted and saved 730 to the content database 570 or other database, or the information is discarded and the user is returned to update profile form.

It should be understood that various changes and modifications to the presently preferred embodiments described herein would be apparent to those skilled in the art. Such changes and modifications may be made without departing from the spirit and scope of the present invention and without diminishing its attendant advantages.

What is claimed is:

1. A sign creation system, comprising:
a content database wherein content for use in creating signs may be stored, and whereby the content may be organized for use in the sign creation system;
a computer connected to said content database;
a sign creation interface on said computer whereby the content from said content database may be customized and viewed using said computer;
a mass sign creation interface on said computer wherein the content for a plurality of different signs intended for different locations may be selected from said content database, and may be customized and viewed using said computer;
an order processing system connected to said computer whereby an order for sign creation may be processed;
a client account management system on said computer whereby one or more client accounts may be organized and information may be collected about a use of the sign creation system on said computer;
a user account management system on said computer whereby a user of the sign creation system may modify information kept within the system about the user's account using said computer; and
a report generating system within the client account management system on said computer whereby reports may be generated on the information collected about a use of the sign creation system on said computer.

2. The sign creation system of claim 1, further comprising:
a personalized template selection interface within the sign creation interface, whereby the content for a sign may be selected from said content database using a hierarchically organized menu.

3. The sign creation system of claim 1, further comprising:
a personalized template selection interface within the sign creation interface whereby the content for a sign may be selected from said content database using an advanced search capability.

4. The sign creation system of claim 1, further comprising
a sign customization interface within the sign creation interface whereby the content for a sign selected from said content database may be customized by adding information to variable fields in the content.

5. The sign creation system of claim 1, further comprising:
a printing facility connected to said order processing system whereby the content from said content database may be printed.

6. The sign creation system of claim 5, further comprising:
a tracking system connected to said order processing system and said printing facility whereby an order may be tracked through processing by the order processing system.

7. The sign creation system of claim 1, further comprising:
a user identification phrase and a password whereby access to the sign creation system through said computer may be restricted;
a first user account access level to said computer, determined by said user identification phrase and password, whereby access to the content on said content database through said computer may be unrestricted; and
a second user account access level to said computer, determined by said user identification phrase and password, whereby access to the content on said content database through said computer may be restricted.

8. The sign creation system of claim 7, further comprising:
an accounting system, connected to said client account management system and said user account management system, whereby a user account access level may be changed.

9. The sign creation system of claim 8, further comprising:
a means for communicating to a user of the sign creation and delivery system a user identification phrase and password for a user account added to the sign creation system through said accounting system.

10. The sign creation system of claim 1, further comprising:
a staging database connected to said computer and said content database whereby the content customized with said sign creation interface may be stored apart from said content database.

11. The sign creation system of claim 1, further comprising:
a credit check within said order processing system whereby credit available to a user of the sign creation system may be checked before an order is submitted in said order processing system.

12. A sign creation system, comprising:
a content database wherein content for use in creating signs may be stored, and whereby the content may be organized for use in the sign creation system;
a computer connected to said content database;
a sign creation interface on said computer whereby the content from said content database may be customized and viewed using said computer;
a client account management system on said computer whereby one or more client accounts may be organized and information may be collected about a use of the sign creation system on said computer; and
a report generating system within the client account management system on said computer whereby reports may be generated on the information collected about a use of the sign creation system on said computer.

13. The sign creation system of claim 12, further comprising:
a mass sign creation interface on said computer wherein the content for a plurality of different signs intended for different locations may be selected from said content database, and may be customized and viewed using said computer.

14. The sign creation system of claim 12, further comprising:
an order processing system connected to said computer whereby an order for sign creation may be processed.

15. The sign creation system of claim 14, further comprising:
a printing facility connected to said order processing system whereby the content from said content database may be printed.

16. The sign creation system of claim 15, further comprising:
a tracking system connected to said order processing system and said printing facility whereby an order may be tracked through processing by the order processing system.

17. The sign creation system of claim 12, further comprising:
a user account management system on said computer whereby a user of the sign creation system may modify information kept within the system about the user's account using said computer.

18. The sign creation system of claim 12, further comprising:
a personalized template selection interface within the sign creation interface, whereby the content for a sign may be selected from said content database using a hierarchically organized menu.

19. The sign creation system of claim 12, further comprising:
a personalized template selection interface within the sign creation interface whereby the content for a sign may be selected from said content database using an advanced search capability.

20. The sign creation system of claim 12, further comprising:
a sign customization interface within the sign creation interface whereby the content for a sign selected from said content database may be customized by adding information to variable fields in the content.

21. The sign creation system of claim 12, further comprising:
a user identification phrase and a password whereby access to the sign creation system through said computer may be restricted;
a first user account access level to said computer, determined by said user identification phrase and password, whereby access to the content on said content database through said computer may be unrestricted; and
a second user account access level to said computer, determined by said user identification phrase and password, whereby access to the content on said content database through said computer may be restricted.

22. The sign creation system of claim 21, further comprising:
an accounting system, connected to said client account management system and said user account management system, whereby a user account access level may be changed.

23. The sign creation system of claim 22, further comprising:
a means for communicating to a user of the sign creation and delivery system a user identification phrase and password for a user account added to the sign creation system through said accounting system.

24. The sign creation system of claim 12, further comprising:
a staging database connected to said computer and said content database whereby the content customized with said sign creation interface may be stored apart from said content database.

25. The sign creation system of claim 12, further comprising:
a credit check within said order processing system whereby credit available to a user of the sign creation system may be checked before an order is submitted in said order processing system.

26. A sign creation system, comprising:
a content database wherein content for use in creating signs may be stored, and whereby the content may be organized for use in the sign creation system;
a computer connected to said content database; and
a sign creation interface on said computer whereby the content from said content database may be customized and viewed using said computer.

27. The sign creation system of claim 26, further comprising:
a report generating system within the client account management system on said computer whereby reports may be generated on the information collected about a use of the sign creation system on said computer.

28. The sign creation system of claim 26, further comprising:
a mass sign creation interface on said computer wherein the content for a plurality of different signs intended for different locations may be selected from said content database, and may be customized and viewed using said computer.

29. The sign creation system of claim 26, further comprising:
a client account management system on said computer whereby one or more client accounts may be organized and information may be collected about a use of the sign creation system on said computer.

30. The sign creation system of claim 26, further comprising:
an order processing system connected to said computer whereby an order for sign creation may be processed.

31. The sign creation system of claim 30, further comprising:
a printing facility connected to said order processing system whereby the content from said content database may be printed.

32. The sign creation system of claim 31, further comprising:
a tracking system connected to said order processing system and said printing facility whereby an order may be tracked through processing by the order processing system.

33. The sign creation system of claim 26, further comprising:
a user account management system on said computer whereby a user of the sign creation system may modify information kept within the system about the user's account using said computer.

34. The sign creation system of claim 26, further comprising:
a personalized template selection interface within the sign creation interface, whereby the content for a sign may be selected from said content database using a hierarchically organized menu.

35. The sign creation system of claim 26, further comprising:
a personalized template selection interface within the sign creation interface whereby the content for a sign may be selected from said content database using an advanced search capability.

36. The sign creation system of claim 26, further comprising:
a sign customization interface within the sign creation interface whereby the content for a sign selected from said content database may be customized by adding information to variable fields in the content.

37. The sign creation system of claim 26, further comprising:
a user identification phrase and a password whereby access to the sign creation system through said computer may be restricted;
a first user account access level to said computer, determined by said user identification phrase and password, whereby access to the content on said content database through said computer may be unrestricted; and
a second user account access level to said computer, determined by said user identification phrase and password, whereby access to the content on said content database through said computer may be restricted.

38. The sign creation system of claim 37, further comprising:
an accounting system, connected to said client account management system and said user account management system, whereby a user account access level may be changed.

39. The sign creation system of claim 38, further comprising:
a means for communicating to a user of the sign creation and delivery system a user identification phrase and password for a user account added to the sign creation system through said accounting system.

40. The sign creation system of claim 26, further comprising:
a staging database connected to said computer and said content database whereby the content customized with said sign creation interface may be stored apart from said content database.

41. The sign creation system of claim 26, further comprising:
a credit check within said order processing system whereby credit available to a user of the sign creation system may be checked before an order is submitted in said order processing system.

42. A method of sign creation, comprising the steps of:
storing information about the content of signs in a content database;
creating customized signs through a user interface with information kept in the content database;
processing an order submitted for creating signs with an automated order processing system;
managing a client account by customizing the user interface with content from the content database, and by collecting information about a client account;
managing a user account by allowing a user to modify information kept about the user's account;
collecting information about what content from the content database is used;
collecting information about how the content used from the content database is customized by a user; and
generating reports with the information collected.

43. The method of sign creation of claim 42, further comprising the step of:
personalizing the user interface with information collected about a user.

44. The method of sign creation of claim 42, further comprising the step of:
searching the content database for content to be used by a user in creating customized signs.

45. The method of sign creation of claim 42, further comprising the step of:
navigating the content database for content to be used by a user with a hierarchically organized menu.

46. The method of sign creation of claim 42, further comprising the step of:
customizing signs created using the content from the content database by adding information to variable fields in the content.

47. The method of sign creation of claim 42, further comprising the step of:
printing orders submitted for processing to the order processing system using.

48. The method of sign creation of claim 47, further comprising the step of:
tracking an order submitted for processing to the order processing system.

49. The method of sign creation of claim 42, further comprising the steps of:
assigning a user identification phrase and a password to a user;
creating one or more user access levels that are associated with a user identification phrase and a password for a user; and
restricting access to the content from the content database to a particular user access level.

50. The method of sign creation of claim 49, further comprising the step of:
keeping an accounting system whereby a user with a particular user access level may be changed to a different user access level.

51. The method of sign creation of claim 50, further comprising the step of:
communicating a user identification phrase and a password to a user after a user access level has been changed.

52. The method of sign creation of claim 42, further comprising the step of:
keeping the content from the content database that has been customized separate from other content from the content database.

53. The method of sign creation of claim 42, further comprising the step of:
checking the credit of a user before processing an order submitted for processing.

54. A method of sign creation, comprising the steps of:
storing information about the content of signs in a content database, and
creating customized signs through a user interface with information kept in the content database.

55. The method of sign creation of claim 54, further comprising the steps of:
collecting information about what content from the content database is used;
collecting information about how the content used from the content database is customized by a user; and
generating reports with the information collected.

56. The method of sign creation of claim 54, further comprising the step of:
managing a client account by customizing the user interface with content from the content database, and by collecting information about a client account.

57. The method of sign creation of claim 54, further comprising the step of:
processing an order submitted for creating signs with an automated order processing system.

58. The method of sign creation of claim 54, further comprising the step of:
printing orders submitted for processing to the order processing system using.

59. The method of sign creation of claim 58, further comprising the step of:
tracking an order submitted for processing to the order processing system.

60. The method of sign creation of claim 54, further comprising the step of:
managing a user account by allowing a user to modify information kept about the user's account.

61. The method of sign creation of claim 54, further comprising the step of:
searching the content database for content to be used by a user in creating customized signs.

62. The method of sign creation of claim 54, further comprising the step of:
navigating the content database for content to be used by a user with a hierarchically organized menu.

63. The method of sign creation of claim 54, further comprising the step of:
customizing signs created using the content from the content database by adding information to variable fields in the content.

64. The method of sign creation of claim 54, further comprising the steps of:
assigning a user identification phrase and a password to a user;
creating one or more user access levels that are associated with a user identification phrase and a password for a user; and
restricting access to the content from the content database to a particular user access level.

65. The method of sign creation of claim 64, further comprising the step of:
keeping an accounting system whereby a user with a particular user access level may be changed to a different user access level.

66. The method of sign creation of claim 65, further comprising the step of:
communicating a user identification phrase and a password to a user after a user access level has been changed.

67. The method of sign creation of claim 54, further comprising the step of:
keeping the content from the content database that has been customized separate from other content from the content database.

68. The method of sign creation of claim 54, further comprising the step of:
checking the credit of a user before processing an order submitted for processing.
